(19) United States
(12) Patent Application Publication
(10) Pub. No.: US 2026/0247325 A1
(43) Pub. Date: Aug. 20, 2026

(54) ASSET TRACKING USING ACOUSTIC WAVES

(71) Applicant: QUALCOMM Incorporated, San Diego, CA (US)

(72) Inventors: Yuxiang PENG, San Jose, CA (US); Jason FILOS, Newark, NJ (US); Weimin DUAN, San Diego, CA (US); Ning LUO, Cupertino, CA (US); Bala RAMASAMY, San Marcos, CA (US)

(21) Appl. No.: 18/994,008

(22) PCT Filed: Jul. 20, 2023
(86) PCT No.: PCT/US2023/028288

§ 371 Date: Jan. 13, 2025

(30) Foreign Application Priority Data
Aug. 16, 2022 (GR) 20220100689

(51) Int. Cl. H04W 64/00; H04B 11/00; H04W 4/38

(52) U.S. Cl. CPC H04W 64/00; H04B 11/00; H04W 4/38

(57) ABSTRACT

Aspects presented herein provide improved sensing and tracking devices that may be used for locating and tracking objects and/or for performing environmental sensing based on AW. The wireless device activates the at least one tracking device associated with the plurality of AWs. The wireless device receives an indication of an activation of at least one tracking device, where the at least one tracking device is associated with a plurality of AWs. The wireless device receives the plurality of AWs from the at least one tracking device, where the plurality of AWs is received prior to performing the set of measurements. The wireless device performs a set of measurements associated with the plurality of AWs from the at least one tracking device. The wireless device obtains a location of the at least one tracking device based on the set of measurements associated with the plurality of AWs.

### CROSS-REFERENCE TO RELATED APPLICATION

This application claims the benefit of Greece Application Serial No. 20220100689, entitled “ASSET TRACKING USING ACOUSTIC WAVES” and filed on Aug. 16, 2022, which is expressly incorporated by reference herein in its entirety.

### TECHNICAL FIELD

The present disclosure relates generally to positioning systems, and more particularly, to positioning systems involving acoustic waves.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus receives an indication of an activation of at least one tracking device, where the at least one tracking device is associated with a plurality of acoustic waves (AWs). The apparatus performs a set of measurements associated with the plurality of AWs from the at least one tracking device. The apparatus obtains a location of the at least one tracking device based on the set of measurements associated with the plurality of AWs.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating example wavelengths for different types of waves in accordance with various aspects of the present disclosure.

FIG. 6 is a flowchart illustrating an example asset tracking procedure based on acoustic wave (AW) in accordance with various aspects of the present disclosure.

FIG. 7 is a diagram illustrating an example environment sensing mode in accordance with various aspects of the present disclosure.

FIG. 8 is a diagram illustrating an example asset tracking with environment sensing in accordance with various aspects of the present disclosure.

FIG. 9A is a diagram illustrating an example impulse-like input stimulus of a captured hand clap in accordance with various aspects of the present disclosure.

FIG. 9B is a diagram illustrating an example filtered output for the captured hand clap in accordance with various aspects of the present disclosure.

FIG. 10 is a flowchart illustrating an example of modifying parameters associated with an environment sensing mode to achieve power consumption in accordance with various aspects of the present disclosure.

FIG. 11A is a diagram illustrating an example initial acoustic scene in an indoor space in accordance with various aspects of the present disclosure.

FIG. 11B is a diagram illustrating an example altered acoustic scene in the indoor space in accordance with various aspects of the present disclosure.

FIG. 12 is a diagram illustrating an example chirp signal in accordance with various aspects of the present disclosure.

FIG. 13 is a flowchart of a method of wireless communication.

FIG. 14 is a flowchart of a method of wireless communication.

FIG. 15 is a diagram illustrating an example of a hardware implementation for an example apparatus and/or network entity.

### DETAILED DESCRIPTION

Aspects presented herein provide improved sensing and tracking devices that may be used for locating and tracking objects and/or for performing environmental sensing (e.g., obtaining information associated with the sensing device and/or the tracking device's surrounding) based on AW. Aspects presented herein may enable a wireless device, such as a UE, a smartphone, a tablet, or an AP device, to be configured to detect one or more objects based on AW using existing hardware components (e.g., microphone(s) and/or speaker(s)) of the wireless device, thereby reducing the cost and complexity of performing the object tracking and/or environmental sensing compared to RF-based sensing and tracking devices.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

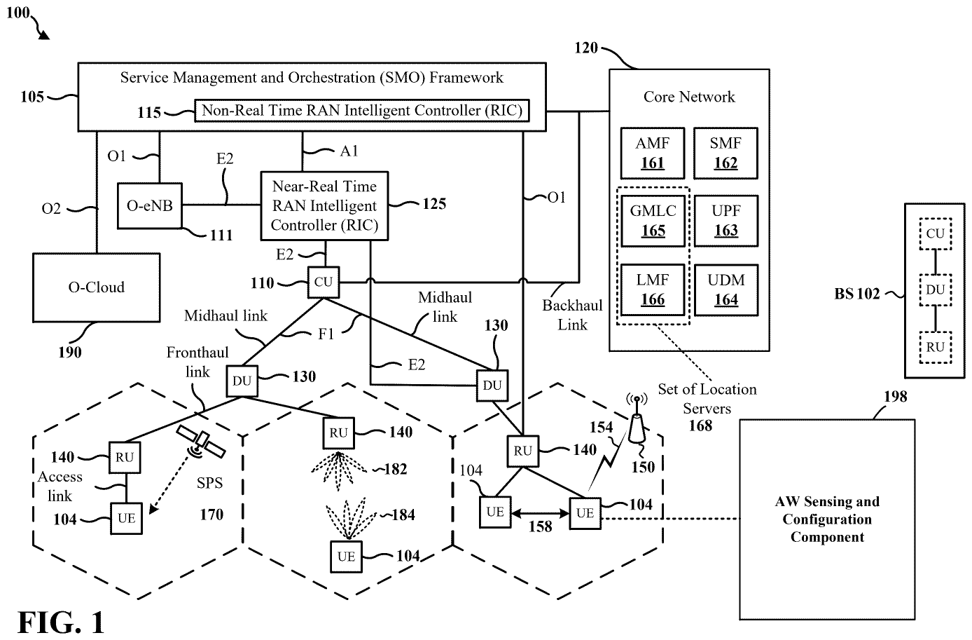

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CUUP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to receive an indication of an activation of at least one tracking device, where the at least one tracking device is associated with a plurality of AWs; perform a set of measurements associated with the plurality of AWs from the at least one tracking device; and obtain a location of the at least one tracking device based on the set of measurements associated with the plurality of AWs (e.g., via the AW sensing and configuration component 198).

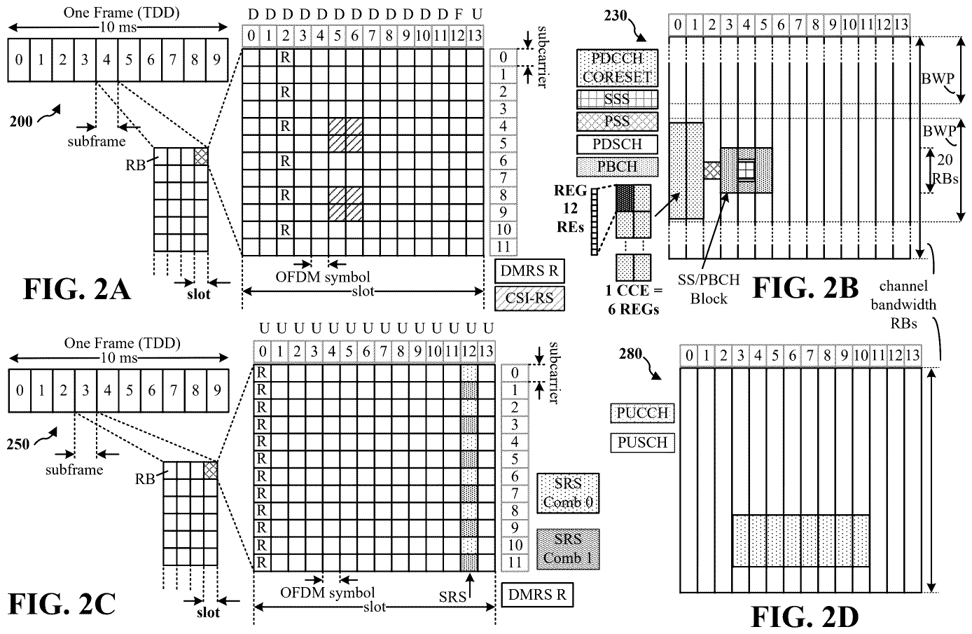

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

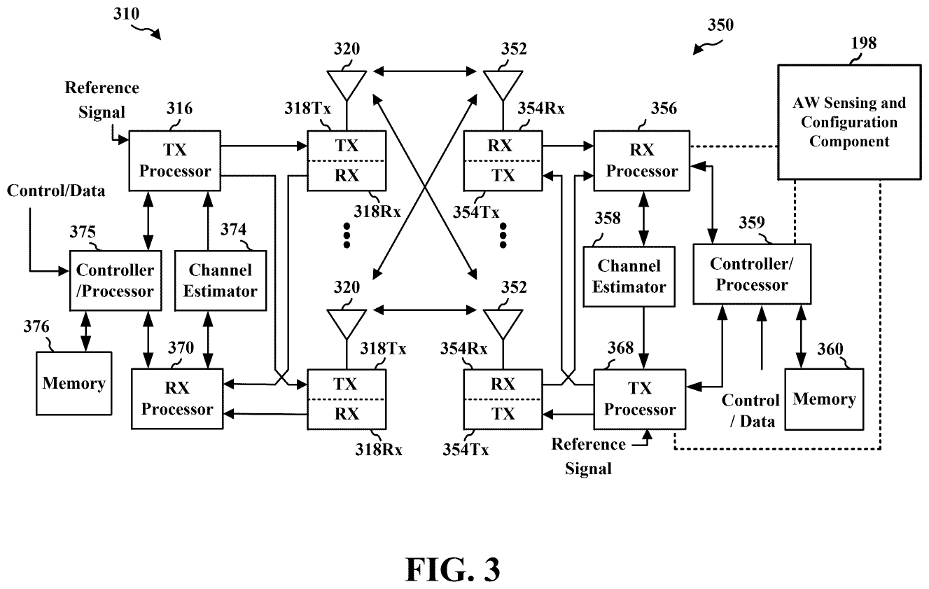

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the AW sensing and configuration component 198 of FIG. 1.

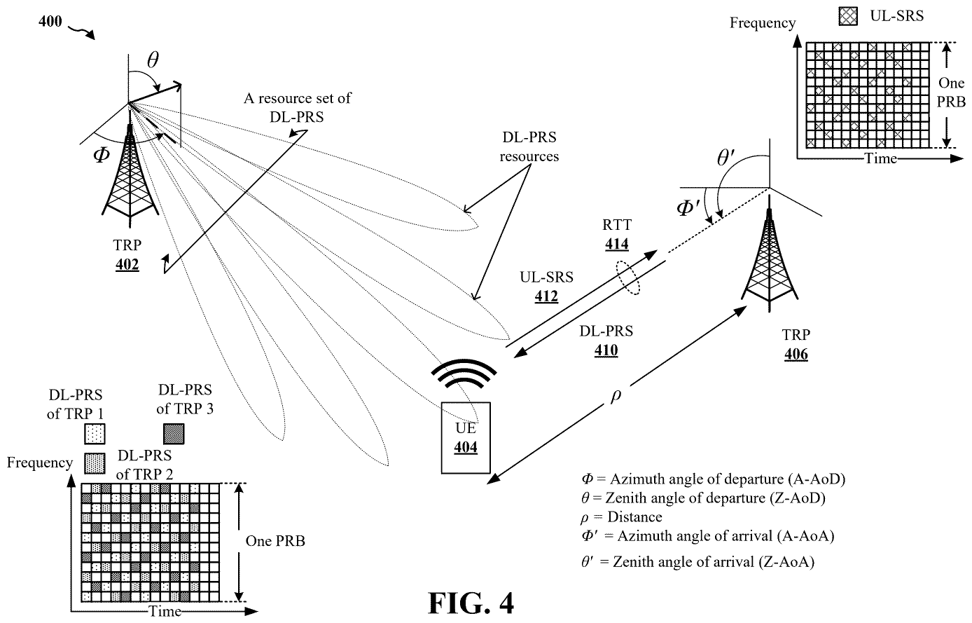

FIG. 4 is a diagram 400 illustrating an example of a UE positioning based on reference signal measurements (which may also be referred to as “network-based positioning”) in accordance with various aspects of the present disclosure. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s)168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and/or DL-PRS-RSRP of the received signals) using assistance data received from the positioning server, and the TRPs 402, 406 measure the gNB Rx-Tx time difference measurements (and/or UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using downlink (DL)-time difference of arrival (TDOA) (DL-TDOA) and/or uplink TODA (UL-TDOA) measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL-PRS-RSRP) of downlink signals received from multiple TRPs 402, 406 at the UE 404. The UE 404 measures the DL RSTD (and/or DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL-SRS-RSRP) at multiple TRPs 402, 406 of uplink signals transmitted from UE 404. The TRPs 402, 406 measure the UL-RTOA (and/or UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information. For purposes of the present disclosure, the suffixes “-based” and “-assisted” may refer respectively to the node that is responsible for making the positioning calculation (and which may also provide measurements) and a node that provides measurements (but which may not make the positioning calculation). For example, an operation in which measurements are provided by a UE to a base station/positioning entity to be used in the computation of a position estimate may be described as “UE-assisted,” “UE-assisted positioning,” and/or “UE-assisted position calculation” while an operation in which a UE computes its own position may be described as “UE-based,” “UE-based positioning,” and/or “UE-based position calculation.”

In addition to network-based UE positioning technologies, a wireless device (e.g., a UE, an access point (AP), etc.) may also be configured to include sensing capabilities, where the wireless device may be able to sense (e.g., detect and/or track) one or more objects of an area or in an environment based on radio frequencies. An environment may refer to a particular geographical area or place, especially as affected by human activity, or the circumstances, objects, or conditions by which one is surrounded. For example, a wireless device may include a radar capability (which may be referred to as “RF sensing” and/or “cellular-based RF sensing), where the wireless device may transmit reference signals (e.g., radar reference signals (RRSs)) and measure the reference signals reflected from one or more objects (e.g., structures, walls, living objects, and/or things in an environment, etc.). Based on the measurement, the wireless device may determine or estimate a distance between the wireless device and the one or more objects and/or obtain environmental information associated with its surrounding. In another example, a first wireless device may receive signals transmitted from a second wireless device, where the first wireless device may determine or estimate a distance between the first wireless device and the second wireless device based on the received signals. For example, a tracking device (e.g., a Bluetooth tracker, an item tracker, an asset tracking device, etc.) may be configured to regularly transmit signals (e.g., beacon signals) or small amounts of data to a receiving device, such that the receiving device may be able to monitor the location or the relative distance of the tracking device. As such, a user may be able to track the location of an item (e.g., a car key, a wallet, a remote control, etc.) by attaching the tracking device to the item. For purposes of the present disclosure, a device/apparatus that is capable of performing sensing (e.g., transmitting and/or receiving signals for detecting at least one object or for estimating the distance between the device and the at least one object) may be referred to as a “sensing device” or a “sensing node.” For example, a sensing device may be a UE, an AP device (e.g., a Wi-Fi router), a base station, a component of the base station, a TRP, a device capable of performing radar functions, etc. In addition, a device/apparatus that is capable of transmitting signals to a sensing device for the sensing device to determine the location or the relative distance of the device/apparatus may be referred to as a “tracking device,” a “tracker,” or a “tag.”

In one example, a sensing device may use acoustic waves (AW) for positioning and localization of one or more objects, which may also be referred to as an acoustic positioning system/device. For example, a sound navigation and ranging (SONAR) system may be used to detect objects under water and/or measure the water's depth by emitting sound pulses and detecting or measuring their return after being reflected. In some scenarios, with comparably slower wave propagation speed (e.g., compared to a radar signal), an acoustic positioning system may be capable of providing sub-meter accuracy for indoor positioning, and provide additional positioning mechanisms. For examples, asset tracking technologies or sensing devices (e.g., GNSS, Wi-Fi, Bluetooth (BT), and/or ultra-wide-band (UWB) based tracking) may typically be configured to use RF or electromagnetic (EM) waves as beacon signals for localization of object(s) and indoor positioning. However, when RF/EM implementations/solutions are not available (e.g., due to hardware limitation or RF interference), utilizing AW (including audible or inaudible sound) on sensing devices may provide an alternative and accessible solution to positioning and localization of objects. In some examples, an AW frequency band that is able to be detected by a UE (e.g., a smartphone, a tablet, etc.) may range approximately from 20 Hz to 23 kHz, while humans may hear sounds in a frequency range from approximately 20 Hz to 20 kHz.

Positioning and/or localization of object(s) based on AW (e.g., AW-based sensing device) may provide various advantages over RF waves (e.g., RF-based sensing device). For example, AW-based sensing devices may use low frequency and slow speed of acoustic signals to reduce cost and/or complexity of ranging hardware, where sampling rates of 40 or 100 kHz may be sufficient to adequately recover audible acoustic signals. Further, as the sound waves may travel slowly (e.g., approximately 344 meters per second), the sampling rate of a standard sound card (48 kHz) may be sufficient for a position sensing granularity under 1 cm. Time synchronization may also be easily achieved due to shorter range (e.g., indoor) deployment and slower wave propagation.

In another example, AW-based sensing devices may provide better power saving compared to RF-based sensing devices. For example, relative to RF-based sensing methods, AW-based or acoustic ranging may shift the power costs from a receiver to a transmitter. An acoustic receiver may not be specified or configured to maintain accurate clocks because the acoustic receiver may rely on post-facto synchronization or TDoA technique, and an acoustic transducer (e.g., an electronic device that converts energy from one form to another) may be operated at a lower power because much of the energy to operate may be drawn from the signal itself. These two factors may enable an acoustic receiver circuitry to power down when it is not in use without loss of functionality.

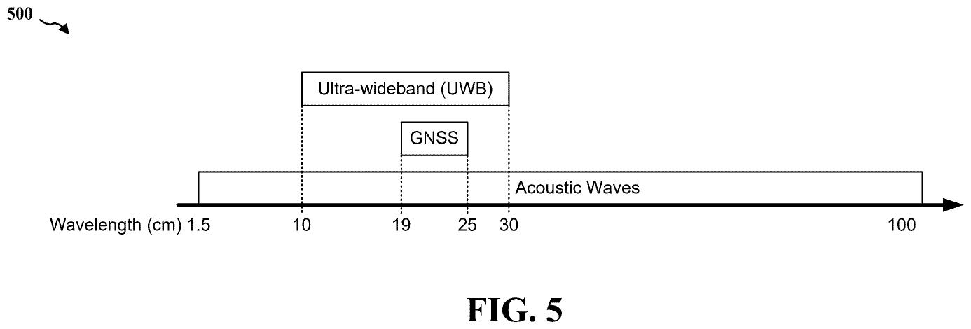

In another example, wide-range wavelengths of AW and acoustic signal may be resilient to a wider range of scattering features. For example, AW may encompass an extremely wide range of wavelengths despite their relatively small range of frequencies. As environmental features of a given size may tend to scatter waves of the same length, this means that a wide-range acoustic signal may be resilient to a wider range of scattering features. FIG. 5 is a diagram 500 illustrating example wavelengths for different types of waves in accordance with various aspects of the present disclosure. In one example, for an acoustic band from 300 Hz through 20 kHz, the component wavelengths may range from 1 meter to 1.5 centimeter (cm). However, an RF UWB ranging system that uses the band from 2 GHz to 3 GHz may just include wavelengths from 30 cm to 10 cm, and the wavelengths for GNSS signals may just range from 19 cm to 25 cm.

Aspects presented herein provide improved sensing and tracking devices that may be used for locating and tracking objects and/or for performing environmental sensing (e.g., obtaining information associated with the sensing device and/or the tracking device's surrounding) based on AW. Aspects presented herein may enable a wireless device, such as a UE, a smartphone, a tablet, or an AP device, to be configured to detect one or more objects based on AW using existing hardware components (e.g., microphone(s) and/or speaker(s)) of the wireless device, thereby reducing the cost and complexity of performing the object tracking and/or environmental sensing compared to RF-based sensing and tracking devices.

In one aspect of the present disclosure, an AW may be designed and configured to be programmable, such as via a UE (e.g., a smartphone). Then, a tracking device, which may be referred to as a “sound tag” or an “AW-based tracking device,” may be configured to transmit (and receive) the programmable AW for tracking and localization of an object (e.g., a thing, a person, an animal, etc.) that is attached to the tracking device. The AW-based tracking devices may provide a competing or even better asset tracking solution compared to RF-based tracking devices. For example, an AW-based tracking device (e.g., a sound tag) may be configured to actively record and playback customized AW signals. By enabling the transmitting AW sound profile to be customizable where unique watermark may be added to the to the AW, the user of an AW-based tracking device may create a private (e.g., a higher privacy) local network. To further enhance the anti-interference or anti-spoofing capability, an AW-based tracking device may be configured to change its transmitting AW profile in real-time based on a unique control from a UE if specified, which may provide a better security. In addition, the transmitting AW profile from an AW-based tracking device may also be a response to the room acoustics, or directly controlled via the AW-based tracking device interface itself. In one example, an AW-based tracking device may be another wireless device with at least one speaker (and also at least one microphone in some implementations). An example use of the AW-based tracking device may include finding a vehicle in a multi-level (three-dimensional (3D)) parking garage at night (e.g., independent of visible light).

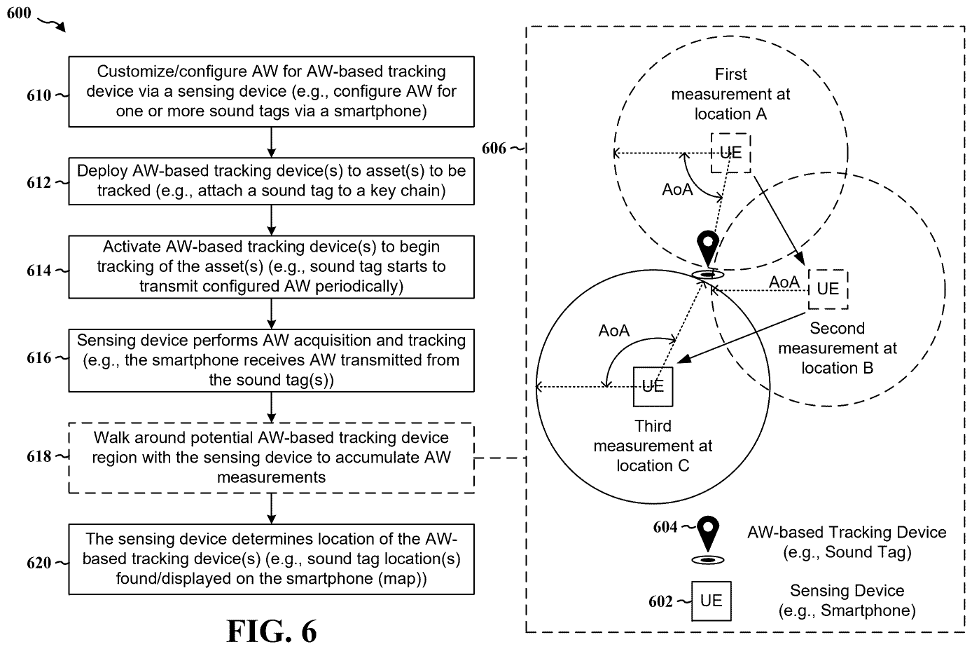

FIG. 6 is a flowchart 600 illustrating an example asset tracking procedure based on AW in accordance with various aspects of the present disclosure. Aspects presented herein may enable a sensing device (e.g., a smartphone, a UE, an AP, etc.) to track one or more AW-based tracking devices (e.g., sound tags).

At 610, AW may be configured or customized for at least one AW-based tracking device 604, such as via a sensing device 602 or via pre-configuration. The configured AW may be associated with a bandwidth (e.g., 20 Hz to 23 kHz) that corresponds to an audible acoustic range, an inaudible acoustic range, an ultrasonic acoustic range, a subsonic acoustic range, or a combination thereof. In some examples, a unique watermark or identifier may be embedded into the AW to improve and security and privacy of the asset tracking. The at least one AW-based tracking device 604 may include at least one speaker, and in some implementations, the at least one AW-based tracking device 604 may further include at least one microphone.

At 612, after the AW is configured or customized for the at least one AW-based tracking device 604, a user may deploy the at least one AW-based tracking device 604 to one or more assets to be tracked. For example, the user may attach the AW-based tracking device 604 to personal items such as a purse, a key chain, or a remote control, etc.

At 614, the at least one AW-based tracking device 604 may be activated to begin tracking and/or monitoring of the one or more assets. For example, the sensing device 602 may transmit an activation indication to the at least one AW-based tracking device 604 to activate the at least one AW-based tracking device 604. In response to the activation indication, the at least one AW-based tracking device 604 may start transmitting the configured AW periodically or at time duration(s) specified (e.g., different periodicities at different times to conserve power). The activation of the at least one AW-based tracking device 604 may also occur before deploying the at least one AW-based tracking device 604 to the one or more assets to be tracked at 612. In another example, the at least one AW-based tracking device 604 may be activated via various methods/means, such as via an activation control/button on the at least one AW-based tracking device 604 itself, or via another wireless device (e.g., a base station, an AP, etc.).

At 616, after the at least one AW-based tracking device 604 is activated, the sensing device 602 may perform AW acquisition and tracking. For example, the sensing device 602 may be configured to monitor for AW transmitted from the at least one AW-based tracking device 604, and the sensing device 602 may perform AW measurement(s) for the AW received. The AW measurement(s) may include an angle of arrival (AoA) for the AW, an angle of departure (AoD) for the AW, a time of arrival (ToA) for the AW, a time difference of arrival (TDoA) of the AW, a distance range for the AW, a reception time of the AW, a power associated with the AW, a Doppler associated with the AW, or a combination thereof. In one example, the at least one AW-based tracking device 604 may be configured to beamform and transmit the AoD of its AW (e.g., via its speaker) to the sensing device 602. Then, the sensing device 602 may compute the AoA of the AW and crosscheck with the AoD information transmitted by the at least one AW-based tracking device 604 to get more a reliable directional information. In some examples, prior to performing the AW acquisition and tracking, the sensing device 602 may receive an indication (e.g., from the at least one AW-based tracking device 604 or another network entity) that the at least one AW-based tracking device 604 has been activated.

In one example, at 618, to improve the asset tracking efficiency and accuracy, the user may carry the sensing device 602 and walk around potential regions where the at least one AW-based tracking device 604 may be located to accumulate different AW measurements from different locations. For example, as shown at 606, the sensing device 602 may be configured to measure AoA of the AW transmitted from the at least one AW-based tracking device 604. As such, when the user carries the sensing device 602 and moves around, the sensing device 602 may be able to obtain different AoA at different locations. For example, the sensing device 602 may obtain a first AoA measurement for the AW transmitted from the at least one AW-based tracking device 604 at a first location, a second AoA measurement at a second location, and a third AoA measurement at a third location, etc. As most smartphones are equipped with multiple (stereo) microphones, AW measurements based on AoA may be readily available without specifying additional hardware component.

At 620, based on the AW measurement(s), the sensing device 620 may determine or estimate the location or the relative distance of the at least one AW-based tracking device 604. For example, as shown at 606, based on the AoA measurements on different locations, the sensing device 602 may be able to calculate an approximate area in which the at least one AW-based tracking device 604 is located. In another example, the ToA of each AW measurement may indicate a distance between the sensing device 602 and the at least one AW-based tracking device 604. Then, using AoA and ToA-based distance, an 3D position for the at least one AW-based tracking device 604 may be fully determined if the position of the sensing device 602 is pre-determined (e.g., via GNSS positioning). In some examples, when there is more than one AW measurement (e.g., as described at 618), the location accuracy for the at least one AW-based tracking device 604 may be improved by running a Kalman filter (KF) or using TDoA (e.g., as the Tx clock may be bias free).

In another aspect of the present disclosure, an AW-based tracking device may be configured to provide environmental information to a sensing device, such that the sensing device may be able to perform environment sensing.

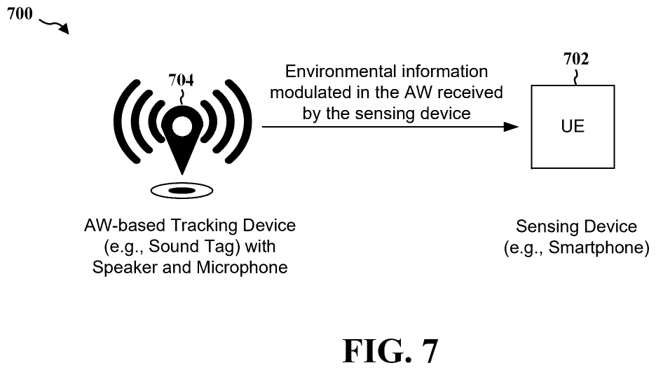

FIG. 7 is a diagram 700 illustrating an example environment sensing mode in accordance with various aspects of the present disclosure. In one example, an AW-based tracking device 704 may include both speaker(s) and microphone(s), such that the AW-based tracking device 704 may both transmit and receive AW (e.g., the AW transmitted by the AW-based tracking device 704 or another device).

As the AW-based tracking device 704 can transmit and receive AW, the AW-based tracking device 704 may be able to sense the nearby environment. For example, the AW-based tracking device 704 may transmit a set of AW and measure the set of AW reflected from one or more objects. Based on the measurement(s) of the reflected AW, the AW-based tracking device 704 may determine one or more environmental conditions, such as whether there are objects (e.g., walls or obstacles) in proximity to the AW-based tracking device 704. Then, the AW-based tracking device 704 may indicate the one or more environmental conditions to a sensing device 702, such as using a specific or pre-defined AW. For example, a first AW configuration may correspond to that there is at least one object within five meters of the AW-based tracking device 704, and a second AW configuration may correspond to a material type, an absorption coefficient, or a reverberation time for an object nearby, etc. As such, the configured AW transmitted from the AW-based tracking device 704 may include the nearby environmental sensing information obtained from an active probing mode (e.g., based on echolocation). In one example, the environmental sensing information may include nearby material types (e.g., determined based on AW absorption coefficients, reverberation time, etc.), location of walls or nearby objects, room shapes, etc. AW absorption coefficient may be used to evaluate the sound absorption efficiency of materials. It is the ratio of absorbed energy to incident energy and is represented by a. If the acoustic energy can be absorbed entirely, then

$$α = 1 : α = \frac{E a}{E i} = 1 - \frac{E τ}{E i} .$$

Reverberation time (RT) may refer to the time specified for the sound in a room to decay over a specific dynamic range, usually taken to be 60 dB, when a source is suddenly interrupted. The Sabine formula relates the RT to the properties of the room may be based on T=0.161V/αS, where V is the volume of the room, S the area of its surfaces, and α the absorption coefficient due to losses in the air and at the surfaces.

In another example, the environmental sensing information may include ambient room temperature. For example, as the speed of sound may be proportional to the temperature in some scenarios, knowing the ambient room temperature may enable a sensing device and/or a tracking device to determine other sensing information (e.g., the material types, the AW absorption coefficients, the location of walls or nearby objects, room shapes, etc.) more accurately. In some examples, a sensing/tracking device may be configured to assume a standard of 20 degrees Celsius in some indoor places. However, if the sensing/tracking device is located at warehouses, there may be a more significant temperature variations. For example, localization of sound sources may be performed based on TDoA measurements. While the propagation speed of sound may be considered as a known constant, due to temperature variations its value may be known just up to some uncertainty. Thus, TDoA-based localization techniques may be used for estimating accurately the actual speed of sound.

In other words, similar to some animals like bats or cetaceans that use echolocation, the AW-based tracking device 704 may use the active AW transmitted by it to sense the acoustic environment and to provide context for the environment. This metadata, for example, may include material types (e.g., absorption coefficients, reverberation time), location of wall(s) or nearby object(s), etc. Then, the AW-based tracking device 704 may contextualize the determined environmental information into the transmitting AW, and the AW may be received by the sensing device 702 to enable the sensing device 702 to better locate or find the AW-based tracking device 704 (e.g., using AW trilateration and the additional metadata). In some examples, the contextual metadata may be embedded directly into the AW, and in other examples, the contextual metadata may be sent as network packet using RF.

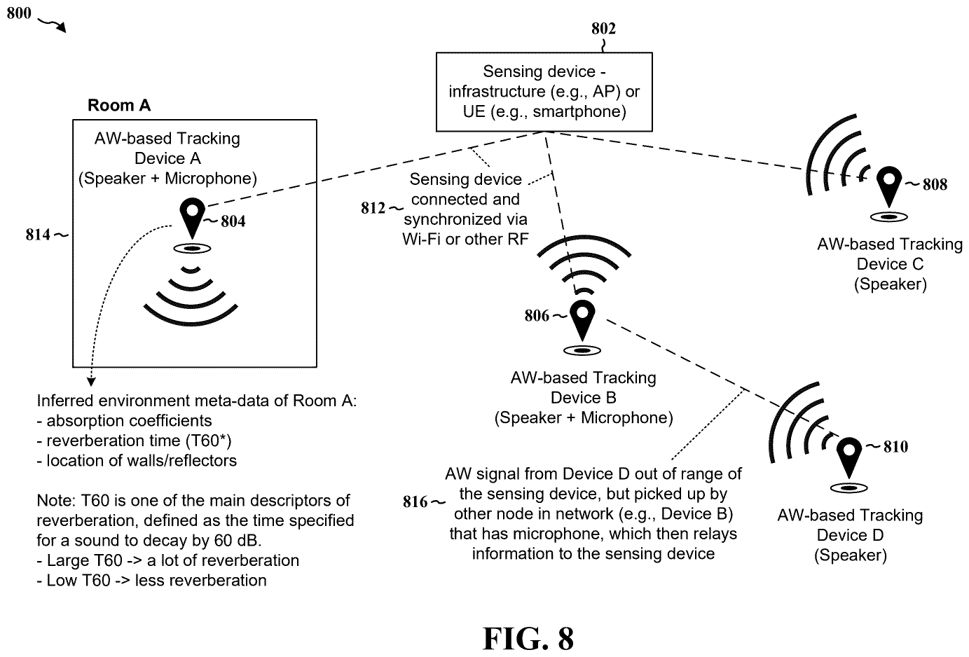

FIG. 8 is a diagram 800 illustrating an example asset tracking with environment sensing in accordance with various aspects of the present disclosure. In one example, multiple AW-based tracking devices (804, 806, 808, 810) may be deployed on multiple objects, such as described in connection with 612 of FIG. 6, where some AW-based tracking devices (e.g., 804 and 806) may include both speaker(s) and microphone(s) and some AW-based tracking devices (e.g., 808 and 810) may include just speaker(s) (e.g., for cost efficiency). Then, the AW-based tracking devices may be activated, such as by a sensing device 802, which may be an infrastructure (e.g., an AP) or a UE (e.g., a smartphone), etc., as described in connection with 614 of FIG. 6. In one example, as shown at 812, the sensing device 812 may be connected to and/or synchronized with the AW-based tracking devices via Wi-Fi or other RF-based communication mechanism (e.g., Bluetooth, UWB, etc.).

As shown at 814, as the AW-based tracking device 804 includes both speaker(s) and microphone(s), the AW-based tracking device 804 may be configured to perform environmental sensing (e.g., based on an active probing mode) and provide environmental information to the sensing device 802, such as described in connection with FIG. 7. For example, the AW-based tracking device 804 may be within a Room A, and during the environmental sensing, the AW-based tracking device 804 may be able to determine the material types (e.g., absorption coefficients, reverberation time), location of wall(s) and/or nearby object(s), etc., associated with the Room A. Then, the AW-based tracking device 804 may contextualize the environmental information associated with the Room A into the transmitting AW, and the AW may be received by the sensing device 802 to enable the sensing device 802 to better locate or find the AW-based tracking device 804 based on the environmental information.

In another example, as shown at 816, an AW-based tracking device with both speaker(s) and microphone(s) may also be configured to relay AW transmitted from another AW-based tracking device to a sensing device 802 to assist the asset tracking. For example, AW transmitted from the AW-based tracking device 810 may not be within the reception range of the sensing device 802, but may be within the reception range of the AW-based tracking device 806 (which is within the reception range of the sensing device 802). As the AW-based tracking device 806 has a microphone and is within the reception range of the sensing device 802, the AW-based tracking device 806 may receive the AW transmitted from the AW-based tracking device 810 and relay the AW (e.g., via its speaker) to the sensing device 802. Thus, the sensing device 802 may still be able to locate the AW-based tracking device 810 even though the AW-based tracking device 810 may not be within its reception range.

In another aspect of the present disclosure, certain sounds, such as snapping of fingers, hand-claps, walking on hard floor, etc., may be impulsive in nature. Thus, these sounds may be used to (blindly) infer a room impulse response (RIR). An RIR may refer to a transfer function between a sound source and a microphone. In order to recover the original sound source, the received microphone signal may be convolved with the inverse of the RIR function. Interpreting impulse responses may be an important part of acoustic analysis. An impulse response measurement may provide information about an environment (e.g., a room) and the way sound will be reproduced within the environment.

In some examples, acoustic impulse responses (AIRs) may infer (or convert to) the RIRs, which may be achieved using a blind system identification (e.g., typically using a blind adaptive filter). Blind system identification may refer to a signal processing technology aimed at retrieving a system's unknown information from its output. A blind adaptive filter may be used to remove the convolutive effect of the system to recover the source signal.

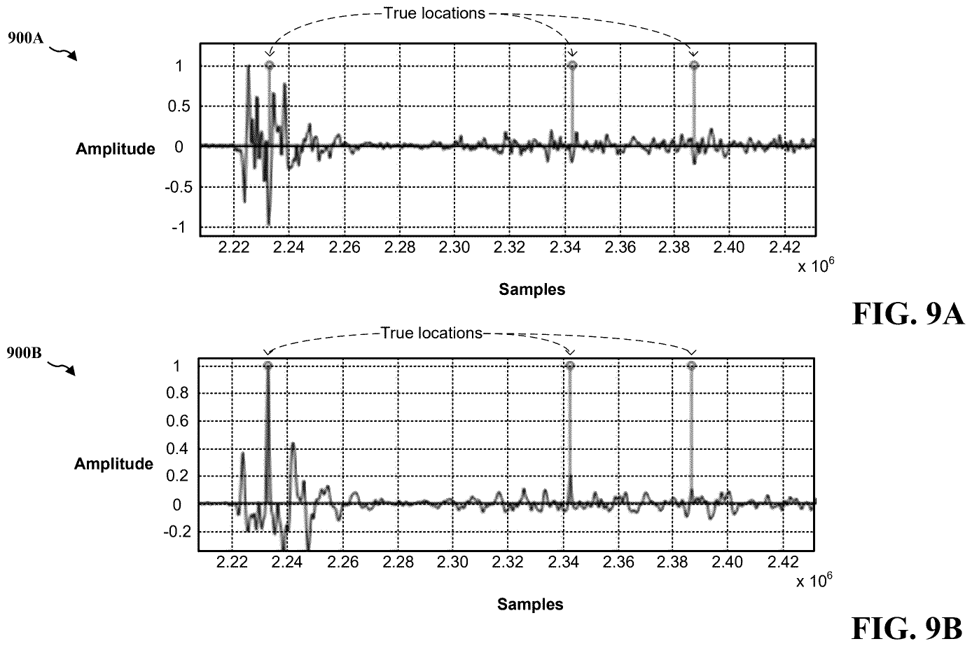

For example, FIG. 9A is a diagram 900A illustrating an example impulse-like input stimulus of a captured hand clap, and FIG. 9B is a diagram 900B illustrating an example filtered output for the captured hand clap in accordance with various aspects of the present disclosure. The peaks in the RIR illustrated by the diagrams 900A and 900B may indicate the arrival times of echoes, and the geometric relationships between them may enable a sensing device to “blindfoldedly” estimate the room geometry. In some examples, different rooms may have different RIRs (e.g., each room geometry may have a unique RIR). In other words, an RIR may be similar to a fingerprint (e.g., a unique feature for identifying different humans). Hence, if a sensing device is capable of estimating the RIR, the sensing device may be able to associate the RIR to a corresponding room or to a particular room geometry.

Measuring or obtaining RIRs may be beneficial for asset tracking. For example, walls of a room may be taken into account by a sensing device during an asset tracking, where the sensing device may be configured to focus on higher-order reflections. In another example, RIRs may enable a sensing device to ‘see’ around corners, so the sensing device does not rely just on line-of-sight signals. RIRs may also be used to detect and track environment changes, such as whether one or more objects in an environment move and/or whether an object moves into or out of an environment. In addition, a sensing device may also adjust its sensing parameters based on RIRs obtained. For example, the sensing device may increase/decrease acquisition speed of AW source (e.g., by using a smaller/larger searching window) depending on the environmental condition(s) and/or optimize power consumption during asset tracking. For example, if an environment does not have a lot of obstacles and walls, a longer search window or periodicity may be configured for a sensing device to reduce the power consumption.

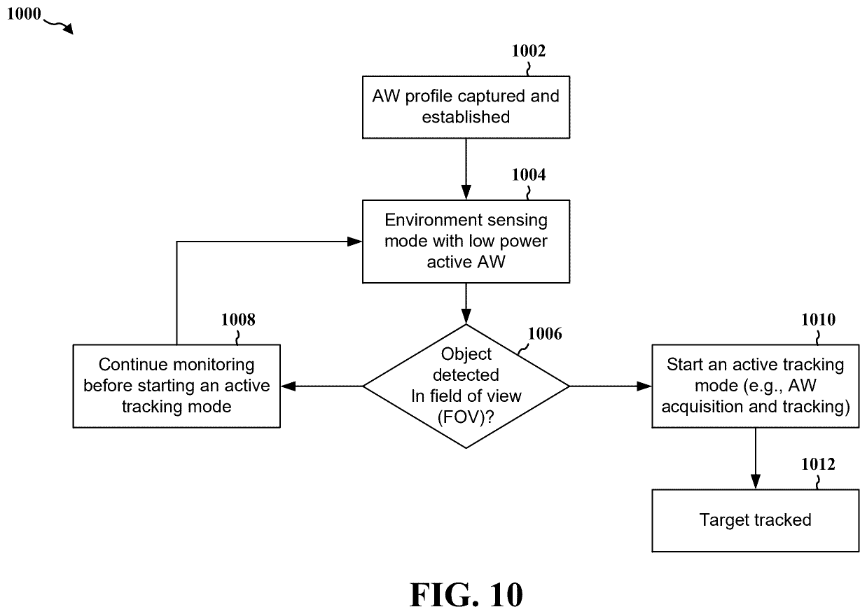

FIG. 10 is a flowchart 1000 illustrating an example of modifying parameters associated with an environment sensing mode to achieve power consumption in accordance with various aspects of the present disclosure. At 1002, AW profile may be configured and established for one or more AW-based tracking devices, such as described in connection with 616 of FIG. 6.

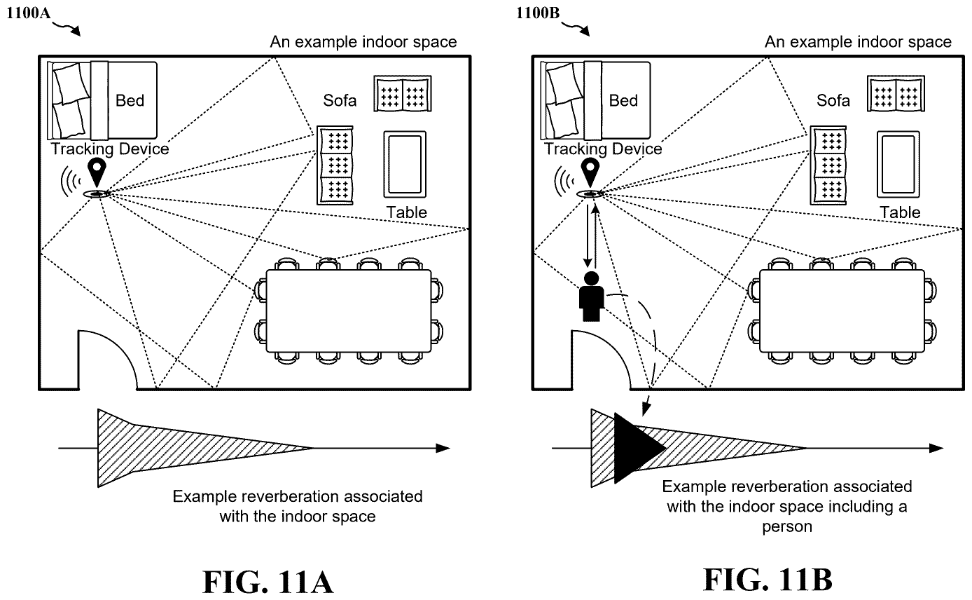

At 1004, an environment sensing mode with lower power active AW (e.g., AW with a longer transmission periodicity, a lower transmission power, etc.) may be activated for the one or more AW-based tracking devices for them to detect one or more objects in an environment. For example, as shown by a diagram 1100A of FIG. 11A of, an AW-based tracking device located in an indoor space may be configured to perform environment sensing, such as by measuring reflections of its transmitted AW periodically (e.g., to obtain a reverberation associated with the indoor space).

At 1006, during the environment sensing mode, the one or more AW-based tracking devices may be configured to detect whether there is an object detected in a field of view (FOV). For example, the one or more AW-based tracking devices may measure the reverberation associated with the indoor space and determine whether there is a change in reverberation.

At 1008, if no object is detected in the FOV, the one or more AW-based tracking devices may continue to perform the environment sensing with lower power active AW.

However, if an object is detected in the FOV, at 1010, the one or more AW-based tracking devices may start an active tracking/sensing mode (e.g., perform the environment sensing with higher power active AW (e.g., AW with a shorter transmission periodicity, a higher transmission power, etc.). For example, as shown by a diagram 1100B of FIG. 11B, after a person enters into the indoor space, the AW-based tracking device may detect that there is a change in reverberation associated with the indoor space. As such, the AW-based tracking device may initiate an active tracking/sensing mode to track the object (e.g., the person) that has entered into the indoor space.

In one example, during the active tracking/sensing mode, the AW-based tracking device may be configured to transmit/play chirps (e.g., signals of length 15 ms every 500 ms) based on a high frequency band (e.g., may be inaudible to person over 45 years of age). Compared to periodic impulse signal, a chirp may be more robust to environmental noise. For example, loudness of periodic signal may be approximately 2.885 sone (e.g., one sone may be arbitrarily set equal to the loudness of a 1,000-Hz tone at a sound level of 40 decibels above the standard reference level), whereas loudness of chirp signal may be approximately 0.96 sone.

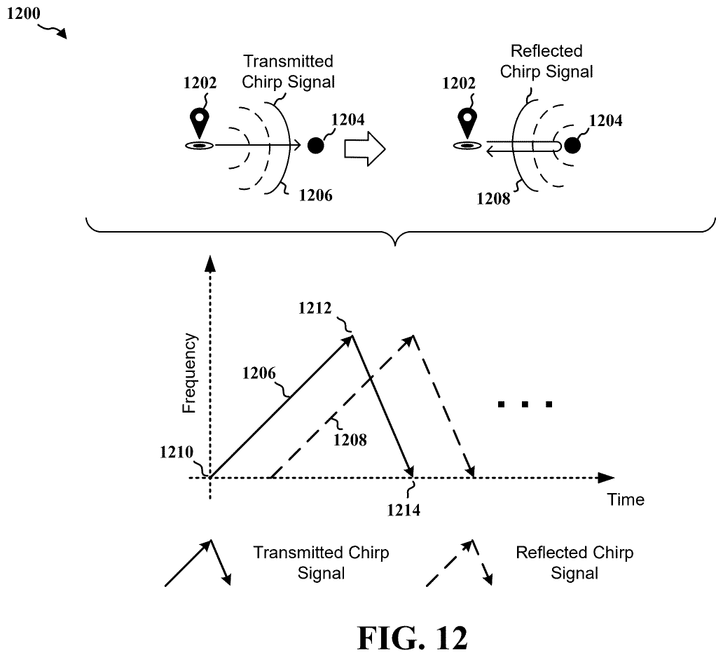

FIG. 12 is a diagram 1200 illustrating an example chirp signal in accordance with various aspects of the present disclosure. An AW-based tracking device 1202 may detect an object 1204 by transmitting chirp signals towards the object 1204 and receiving the chirp signals reflected (e.g., bounce off) from the object 1204. A chirp signal may refer to a signal that has a frequency that varies linearly (e.g., has a frequency sweeping) over a fixed period of time (e.g., over a sweep time) by a modulating signal. For example, as shown by the diagram 1200, a transmitted chirp signal 1206 may have a starting frequency at 1210 of a sinusoid. Then, the frequency may gradually (e.g., linearly) increase on the sinusoid until it reaches an ending (or highest) frequency at 1212 of the sinusoid, and then the frequency of the signal may return to the starting frequency as shown at 1214 and another chirp signal may be transmitted in the same way. In other words, each chirp signal may include an increase in frequency (e.g., linearly) and a drop in frequency or vice versa (e.g., including a decrease in frequency and then an increase in frequency), such that the AW-based tracking device 1202 may transmit chirp signals sweeping in frequency. After the chirp signal 1206 is transmitted by the AW-based tracking device 1202, the transmitted chirp signal may reach the object 1204 and reflect back to the AW-based tracking device 1202, such as shown by the reflected chirp signal 1208. As there may be a distance between the AW-based tracking device 1202 and the object 1204 and/or it may take time for a transmitted chirp signal to reach the object 1204 and reflect back to the AW-based tracking device 1202, a delay may exist between a transmitted chirp signal and its corresponding reflected chirp signal. As the delay may be proportional to a range between the AW-based tracking device 1202 and the object 1204 (e.g., the further the target, the larger the delay and vice versa), the AW-based tracking device 1202 may be able to measure or estimate a distance between the AW-based tracking device 1202 and the object 1204 based on the delay.

Referring back to FIG. 10, at 1012, after the target is tracked, the one or more AW-based tracking devices may be configured to initiate additional action(s). For example, the one or more AW-based tracking devices may be configured to inform a corresponding sensing device regarding the detection of a new object in an environment, such as notifying a user via a smartphone that an intruder has entered into a house if the one or more AW-based tracking devices are configured to detect intruder under an intruder detection mode. On the other hand, if a target is tracked and then disappeared (e.g., left the indoor space), the one or more AW-based tracking devices may resume to performing the environment sensing with the lower power active AW (e.g., back to step 1004).

In another aspects of the present disclosure, a sensing device may utilize AW measurements (as described in connection with 616, 618, and 620 of FIG. 6) to improve RF-based asset tracking and/or communication. For example, information associated with AoA and/or AoD of AW (e.g., from an AW-based tracking device) may be utilized to explore a robust solution for RF signal none-line-of-sight (NLOS) or line-of-sight (LOS) detection and mitigation. For example, by deploying an AW-based system that is capable of beamforming the direction of sound and get the AoA or/and AoD of the sound, communication or positioning performance of RF systems may be enhanced. In another example, by knowing obstacles in an environment (e.g., walls and furniture in an indoor spacing) based on AW environmental sensing, a sensing device (e.g., a UE, a smartphone) may beamform its communication signals toward directions with less obstacles to improve its RF-based communication.

In another example, as UWB may be inferred, there may be chances of false positives measured by a UWB device, such as in NLOS and multi-floor scenarios. If a UWB device is capable of transmitting and beamforming directional AW, the NLOS UWB signals may be detected according to directional AW information. In this way, the positioning algorithm may label, de-weight or remove the NLOS UWB signals.

In another example, compared to RF waves, AW may penetrate certain objects (e.g., water, light wall) better than RF waves. Such characteristics may also enable a more robust tracking solution for wearables (e.g., elderly, children, pets, under water items, etc.). In some examples, use of AW for asset tracking may also enhance the location awareness level RF-based tracking solutions.

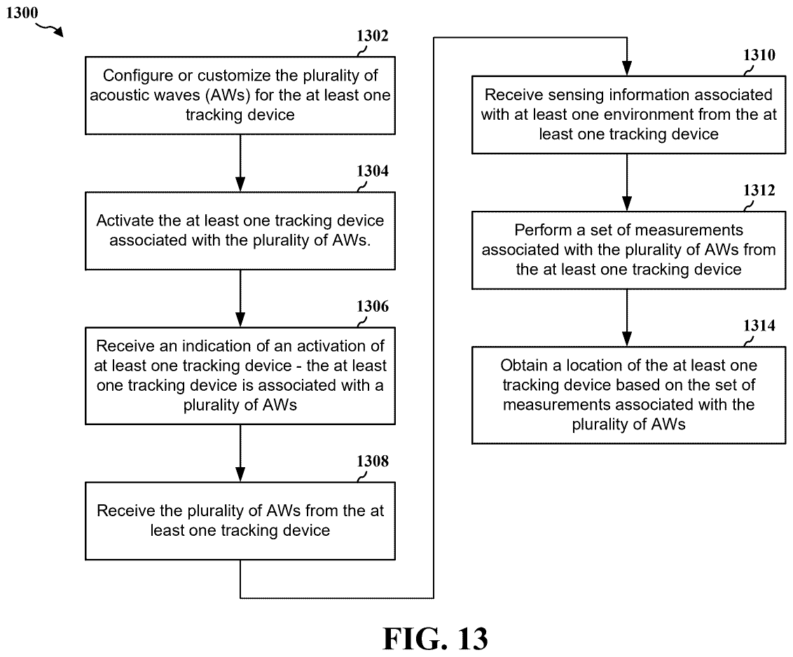

FIG. 13 is a flowchart 1300 of a method of wireless communication. The method may be performed by a wireless device (e.g., the UE 104, 404; the sensing device 602, 702, 802; the apparatus 1504). The method may enable the wireless device to perform asset tracking with one or more tracking devices based on AW.

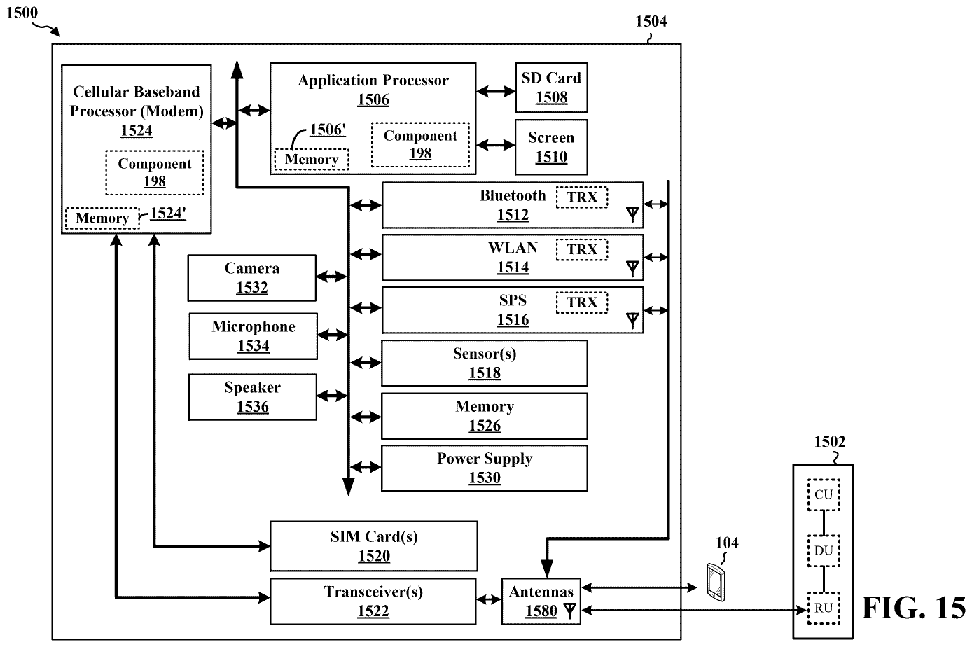

At 1302, the wireless device may configure or customize the plurality of AWs for the at least one tracking device, such as described in connection with FIG. 6. For example, at 610 of FIG. 6, the sensing device 602 may customize/configure AW for AW-based tracking device 604. The configuration/customization of the plurality of AWs for the at least one tracking device may be performed by, e.g., the AW sensing and configuration component 198, the cellular baseband processor 1524, the speaker 1536, and/or the transceiver(s) 1522 of the apparatus 1504 in FIG. 15.

In one example, the plurality of AWs is associated with a bandwidth that corresponds to at least one of: an audible acoustic range, an ultrasonic acoustic range, or a subsonic acoustic range.

In another example, the plurality of AWs is associated with a bandwidth between 20 Hz and 23 kHz or a wavelength between 1 meter and 1.5 centimeter.

At 1304, the wireless device may activate the at least one tracking device associated with the plurality of AWs, such as described in connection with FIG. 6. For example, at 614 of FIG. 6, the sensing device 602 may activate AW-based tracking device 604 to begin tracking of an asset. The activation of the at least one tracking device may be performed by, e.g., the AW sensing and configuration component 198, the cellular baseband processor 1524, the speaker 1536, and/or the transceiver(s) 1522 of the apparatus 1504 in FIG. 15. In one example, the at least one tracking device is activated based on the indication of the activation.

At 1306, the wireless device may receive an indication of an activation of at least one tracking device, where the at least one tracking device is associated with a plurality of AWs, such as described in connection with FIG. 6. For example, at 616 of FIG. 6, the sensing device 602 may start receiving AW transmitted from the AW-based tracking device 604 after the AW-based tracking device 604 is activated. In another, prior to performing the AW acquisition and tracking, the sensing device 602 may receive an indication (e.g., from the at least one AW-based tracking device 604 or another network entity) that the at least one AW-based tracking device 604 has been activated. The reception of the indication of an activation of at least one tracking device may be performed by, e.g., the AW sensing and configuration component 198, the cellular baseband processor 1524, the microphone 1534, and/or the transceiver(s) 1522 of the apparatus 1504 in FIG. 15.

In one example, the at least one tracking device includes a speaker and a microphone.

In another example, the wireless device is a UE, an AP, or an infrastructure.

At 1308, the wireless device may receive the plurality of AWs from the at least one tracking device, such as described in connection with FIG. 6. For example, at 616 and 618 of FIG. 6, the sensing device 602 may receive AW transmitted from the at least one AW-based tracking device 604. The reception of the plurality of AWs may be performed by, e.g., the AW sensing and configuration component 198, the cellular baseband processor 1524, the microphone 1534, and/or the transceiver(s) 1522 of the apparatus 1504 in FIG. 15.

In one example, the wireless device may receive information associated with one or more locations of one or more walls in at least one environment from the at least one tracking device, where the information is received based on RIRs or AIRs, and the wireless device may modify at least one parameter associated with performing the set of measurements based on the information associated with the one or more locations of the one or more walls. In such an example, the at least one parameter includes at least one of: an acquisition speed for the plurality of AWs, power for receiving or monitoring the plurality of AWs, or an LOS or NLOS configuration for receiving the plurality of AWs.

At 1310, the wireless device may receive sensing information associated with at least one environment from the at least one tracking device, such as described in connection with FIGS. 7 and 8. For example, the sensing device 702 may receive sensing information associated with at least one environment from the AW-based tracking device 704. The reception of the sensing information may be performed by, e.g., the AW sensing and configuration component 198, the cellular baseband processor 1524, the microphone 1534, and/or the transceiver(s) 1522 of the apparatus 1504 in FIG. 15.

In one example, the sensing information includes at least one of: material types, absorption coefficients, or reverberation time for one or more objects in the at least one environment, one or more first locations of one or more walls in the at least one environment, or one or more second locations of one or more nearby objects to the at least one tracking device.

In another example, the location of the at least one tracking device is obtained further based on the sensing information.

At 1312, the wireless device may perform a set of measurements associated with the plurality of AWs from the at least one tracking device, such as described in connection with FIG. 6. For example, at 616 and 618 of FIG. 6, the sensing device 602 may perform AW measurements for AWs received from the at least one AW-based tracking device 604. The set of measurements may be performed by, e.g., the AW sensing and configuration component 198 and/or the cellular baseband processor 1524 of the apparatus 1504 in FIG. 15.

In one example, the set of measurements includes at least one of: an AoA for the plurality of AWs, an AoD for the plurality of AWs, a TDoA of the plurality of AWs, a distance range for the plurality of AWs, a reception time of the plurality of AWs, a power associated with the plurality of AWs, or a Doppler associated with the plurality of AWs.

At 1314, the wireless device may obtain a location of the at least one tracking device based on the set of measurements associated with the plurality of AWs, such as described in connection with FIG. 6. For example, at 620 of FIG. 6, the sensing device 602 may determine the location of the AW-based tracking device 604 based on the AW measurements. The obtaining of the location of the at least one tracking device may be performed by, e.g., the AW sensing and configuration component 198, the cellular baseband processor 1524, the speaker 1536, and/or the transceiver(s) 1522 of the apparatus 1504 in FIG. 15.

In one example, the wireless device may transmit a second indication of the location of the at least one tracking device after obtaining the location of the at least one tracking device.

In another example, the wireless device may determine at least one object that is not previously presented in an environment enters the environment based on the set of measurements associated with the plurality of AWs from the at least one tracking device, and the wireless device may track at least one of a motion or a second location of the at least one object based on the plurality of AWs from the at least one tracking device.

In another example, the wireless device may determine whether an RF signal is under an LOS or an NLOS condition based on the set of measurements. In such an example, the wireless device may label, de-weight, or remove the RF signal in response to the RF signal being under the NLOS condition.

In another example, the wireless device may perform RF communication, tracking, or positioning based on the set of measurements associated with the plurality of AWs.

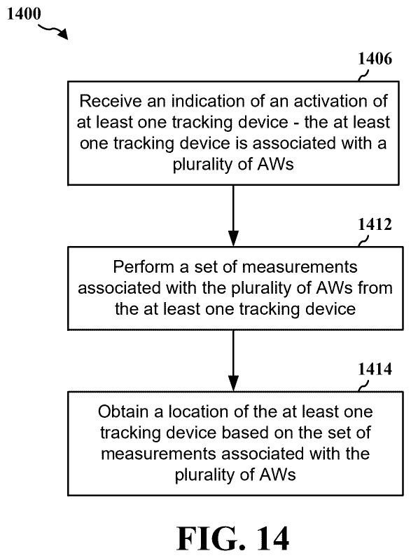

FIG. 14 is a flowchart 1400 of a method of wireless communication. The method may be performed by a wireless device (e.g., the UE 104, 404; the sensing device 602, 702, 802; the apparatus 1504). The method may enable the wireless device to perform asset tracking with one or more tracking devices based on AW.

At 1406, the wireless device may receive an indication of an activation of at least one tracking device, where the at least one tracking device is associated with a plurality of AWs, such as described in connection with FIG. 6. For example, at 616 of FIG. 6, the sensing device 602 may start receiving AW transmitted from the AW-based tracking device 604 after the AW-based tracking device 604 is activated. In another, prior to performing the AW acquisition and tracking, the sensing device 602 may receive an indication (e.g., from the at least one AW-based tracking device 604 or another network entity) that the at least one AW-based tracking device 604 has been activated. The reception of the indication of an activation of at least one tracking device may be performed by, e.g., the AW sensing and configuration component 198, the cellular baseband processor 1524, the microphone 1534, and/or the transceiver(s) 1522 of the apparatus 1504 in FIG. 15.

In one example, the wireless device may configure or customize the plurality of AWs for the at least one tracking device, such as described in connection with FIG. 6. For example, at 610 of FIG. 6, the sensing device 602 may customize/configure AW for AW-based tracking device 604. The configuration/customization of the plurality of AWs for the at least one tracking device may be performed by, e.g., the AW sensing and configuration component 198, the cellular baseband processor 1524, the speaker 1536, and/or the transceiver(s) 1522 of the apparatus 1504 in FIG. 15.

In another example, the plurality of AWs is associated with a bandwidth that corresponds to at least one of: an audible acoustic range, an ultrasonic acoustic range, or a subsonic acoustic range.

In another example, the plurality of AWs is associated with a bandwidth between 20 Hz and 23 kHz or a wavelength between 1 meter and 1.5 centimeter.

In another example, the wireless device may activate the at least one tracking device associated with the plurality of AWs, such as described in connection with FIG. 6. For example, at 614 of FIG. 6, the sensing device 602 may activate AW-based tracking device 604 to begin tracking of an asset. The activation of the at least one tracking device may be performed by, e.g., the AW sensing and configuration component 198, the cellular baseband processor 1524, the speaker 1536, and/or the transceiver(s) 1522 of the apparatus 1504 in FIG. 15. In one example, the at least one tracking device is activated based on the indication of the activation.

In another example, the at least one tracking device includes a speaker and a microphone.

In another example, the wireless device is a UE, an AP, or an infrastructure.

In another example, the wireless device may receive the plurality of AWs from the at least one tracking device, such as described in connection with FIG. 6. For example, at 616 and 618 of FIG. 6, the sensing device 602 may receive AW transmitted from the at least one AW-based tracking device 604. The reception of the plurality of AWs may be performed by, e.g., the AW sensing and configuration component 198, the cellular baseband processor 1524, the microphone 1534, and/or the transceiver(s) 1522 of the apparatus 1504 in FIG. 15. In one example, the wireless device may receive information associated with one or more locations of one or more walls in at least one environment from the at least one tracking device, where the information is received based on RIRs or AIRs, and the wireless device may modify at least one parameter associated with performing the set of measurements based on the information associated with the one or more locations of the one or more walls. In such an example, the at least one parameter includes at least one of: an acquisition speed for the plurality of AWs, power for receiving or monitoring the plurality of AWs, or an LOS or NLOS configuration for receiving the plurality of AWs.

In another example, the wireless device may receive sensing information associated with at least one environment from the at least one tracking device, such as described in connection with FIGS. 7 and 8. For example, the sensing device 702 may receive sensing information associated with at least one environment from the AW-based tracking device 704. The reception of the sensing information may be performed by, e.g., the AW sensing and configuration component 198, the cellular baseband processor 1524, the microphone 1534, and/or the transceiver(s) 1522 of the apparatus 1504 in FIG. 15. In such an example, the sensing information includes at least one of: material types, absorption coefficients, or reverberation time for one or more objects in the at least one environment, one or more first locations of one or more walls in the at least one environment, or one or more second locations of one or more nearby objects to the at least one tracking device. In another example, the location of the at least one tracking device is obtained further based on the sensing information.

At 1412, the wireless device may perform a set of measurements associated with the plurality of AWs from the at least one tracking device, such as described in connection with FIG. 6. For example, at 616 and 618 of FIG. 6, the sensing device 602 may perform AW measurements for AWs received from the at least one AW-based tracking device 604. The set of measurements may be performed by, e.g., the AW sensing and configuration component 198 and/or the cellular baseband processor 1524 of the apparatus 1504 in FIG. 15.

In one example, the set of measurements includes at least one of: an AoA for the plurality of AWs, an AoD for the plurality of AWs, a TDoA of the plurality of AWs, a distance range for the plurality of AWs, a reception time of the plurality of AWs, a power associated with the plurality of AWs, or a Doppler associated with the plurality of AWs.

At 1414, the wireless device may obtain a location of the at least one tracking device based on the set of measurements associated with the plurality of AWs, such as described in connection with FIG. 6. For example, at 620 of FIG. 6, the sensing device 602 may determine the location of the AW-based tracking device 604 based on the AW measurements. The obtaining of the location of the at least one tracking device may be performed by, e.g., the AW sensing and configuration component 198, the cellular baseband processor 1524, the speaker 1536, and/or the transceiver(s) 1522 of the apparatus 1504 in FIG. 15.

In one example, the wireless device may transmit a second indication of the location of the at least one tracking device after obtaining the location of the at least one tracking device.

In another example, the wireless device may determine at least one object that is not previously presented in an environment enters the environment based on the set of measurements associated with the plurality of AWs from the at least one tracking device, and the wireless device may track at least one of a motion or a second location of the at least one object based on the plurality of AWs from the at least one tracking device.

In another example, the wireless device may determine whether an RF signal is under an LOS or an NLOS condition based on the set of measurements. In such an example, the wireless device may label, de-weight, or remove the RF signal in response to the RF signal being under the NLOS condition.

In another example, the wireless device may perform RF communication, tracking, or positioning based on the set of measurements associated with the plurality of AWs.

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include a cellular baseband processor 1524 (also referred to as a modem) coupled to one or more transceivers 1522 (e.g., cellular RF transceiver). The cellular baseband processor 1524 may include on-chip memory 1524′. In some aspects, the apparatus 1504 may further include at least one microphone 1534 and/or at least one speaker 1536, where the at least one microphone 1534 may receive AWs and the at least one speaker 1536 may transmit AWs. In some aspects, the apparatus 1504 may further include one or more subscriber identity modules (SIM) cards 1520 and an application processor 1506 coupled to a secure digital (SD) card 1508 and a screen 1510. The application processor 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor 1524 communicates through the transceiver(s) 1522 via one or more antennas 1580 with the UE 104 and/or with an RU associated with a network entity 1502. The cellular baseband processor 1524 and the application processor 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor 1524 and the application processor 1506 are each responsible for general processing, including the execution of software stored on the computer-readable medium/memory. The software, when executed by the cellular baseband processor 1524/application processor 1506, causes the cellular baseband processor 1524/application processor 1506 to perform the various functions described supra. The computer-readable medium/memory may also be used for storing data that is manipulated by the cellular baseband processor 1524/application processor 1506 when executing software. The cellular baseband processor 1524/application processor 1506 may be a component of the UE 350 and may include the memory 360 and/or at least one of the TX processor 368, the RX processor 356, and the controller/processor 359. In one configuration, the apparatus 1504 may be a processor chip (modem and/or application) and include just the cellular baseband processor 1524 and/or the application processor 1506, and in another configuration, the apparatus 1504 may be the entire UE (e.g., see 350 of FIG. 3) and include the additional modules of the apparatus 1504.

As discussed supra, the AW sensing and configuration component 198 may be configured to receive an indication of an activation of at least one tracking device, where the at least one tracking device is associated with a plurality of AWs. The AW sensing and configuration component 198 may also be configured to perform a set of measurements associated with the plurality of AWs from the at least one tracking device. The AW sensing and configuration component 198 may also be configured to obtain a location of the at least one tracking device based on the set of measurements associated with the plurality of AWs. The AW sensing and configuration component 198 may be within the cellular baseband processor 1524, the application processor 1506, or both the cellular baseband processor 1524 and the application processor 1506. The AW sensing and configuration component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1504 may include a variety of components configured for various functions. In one configuration, the apparatus 1504, and in particular the cellular baseband processor 1524 and/or the application processor 1506, may include means for receiving an indication of an activation of at least one tracking device, where the at least one tracking device is associated with a plurality of AWs. The apparatus 1504 may further include means for performing a set of measurements associated with the plurality of AWs from the at least one tracking device. The apparatus 1504 may further include means for obtaining a location of the at least one tracking device based on the set of measurements associated with the plurality of AWs.

In one configuration, the apparatus 1504 may further include means for configuring or customizing the plurality of AWs for the at least one tracking device.

In another configuration, the plurality of AWs is associated with a bandwidth that corresponds to at least one of: an audible acoustic range, an ultrasonic acoustic range, or a subsonic acoustic range.

In another configuration, the plurality of AWs is associated with a bandwidth between 20 Hz and 23 kHz or a wavelength between 1 meter and 1.5 centimeter.

In another configuration, the apparatus 1504 may further include means for activating the at least one tracking device associated with the plurality of AWs. In such a configuration, the at least one tracking device is activated based on the indication of the activation.

In another configuration, the at least one tracking device includes a speaker and a microphone.

In another configuration, the wireless device is a UE, an AP, or an infrastructure.

In another configuration, the apparatus 1504 may further include means for receiving the plurality of AWs from the at least one tracking device.

In another configuration, the apparatus 1504 may further include means for receiving information associated with one or more locations of one or more walls in at least one environment from the at least one tracking device, where the information is received based on RIRs or AIRs, and the apparatus 1504 may further include means for modifying at least one parameter associated with performing the set of measurements based on the information associated with the one or more locations of the one or more walls. In such a configuration, the at least one parameter includes at least one of: an acquisition speed for the plurality of AWs, power for receiving or monitoring the plurality of AWs, or an LOS or NLOS configuration for receiving the plurality of AWs.

In another configuration, the apparatus 1504 may further include means for receiving sensing information associated with at least one environment from the at least one tracking device. In such a configuration, the sensing information includes at least one of: material types, absorption coefficients, or reverberation time for one or more objects in the at least one environment, one or more first locations of one or more walls in the at least one environment, or one or more second locations of one or more nearby objects to the at least one tracking device. In another configuration, the location of the at least one tracking device is obtained further based on the sensing information.

In one configuration, the set of measurements includes at least one of: an AoA for the plurality of AWs, an AoD for the plurality of AWs, a TDoA of the plurality of AWs, a distance range for the plurality of AWs, a reception time of the plurality of AWs, a power associated with the plurality of AWs, or a Doppler associated with the plurality of AWs.

In one configuration, the apparatus 1504 may further include means for transmitting a second indication of the location of the at least one tracking device after obtaining the location of the at least one tracking device.

In another configuration, the apparatus 1504 may further include means for determining at least one object that is not previously presented in an environment enters the environment based on the set of measurements associated with the plurality of AWs from the at least one tracking device, and the apparatus 1504 may further include means for tracking at least one of a motion or a second location of the at least one object based on the plurality of AWs from the at least one tracking device.

In another configuration, the apparatus 1504 may further include means for determining whether an RF signal is under an LOS or an NLOS condition based on the set of measurements. In such a configuration, the apparatus 1504 may further include means for labeling, de-weighting, or removing the RF signal in response to the RF signal being under the NLOS condition.

In another configuration, the apparatus 1504 may further include means for performing RF communication, tracking, or positioning based on the set of measurements associated with the plurality of AWs.

The means may be the AW sensing and configuration component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a wireless device, including: receive an indication of an activation of at least one tracking device, where the at least one tracking device is associated with a plurality of AWs; perform a set of measurements associated with the plurality of AWs from the at least one tracking device; and obtain a location of the at least one tracking device based on the set of measurements associated with the plurality of AWs.
Aspect 2 is the method of aspect 1, where the plurality of AWs is associated with a bandwidth that corresponds to at least one of: an audible acoustic range, an ultrasonic acoustic range, or a subsonic acoustic range.
Aspect 3 is the method of any of aspects 1 or 2, further including: activating the at least one tracking device associated with the plurality of AWs.
Aspect 4 is the method of aspect 3, where the at least one tracking device is activated based on the indication of the activation.
Aspect 5 is the method of any of aspects 1 to 4, further including: receiving the plurality of AWs from the at least one tracking device, where the plurality of AWs is received prior to performing the set of measurements.
Aspect 6 is the method of any of aspects 1 to 5, where the set of measurements includes at least one of: an AoA for the plurality of AWs, an AoD for the plurality of AWs, a TDoA of the plurality of AWs, a distance range for the plurality of AWs, a reception time of the plurality of AWs, a power associated with the plurality of AWs, or a Doppler associated with the plurality of AWs.
Aspect 7 is the method of any of aspects 1 to 6, further including: transmitting a second indication of the location of the at least one tracking device after obtaining the location of the at least one tracking device.
Aspect 8 is the method of any of aspects 1 to 7, further including: receiving sensing information associated with at least one environment from the at least one tracking device.
Aspect 9 is the method of aspect 8, where the sensing information includes at least one of: material types, absorption coefficients, or reverberation time for one or more objects in the at least one environment, one or more first locations of one or more walls in the at least one environment, or one or more second locations of one or more nearby objects to the at least one tracking device.
Aspect 10 is the method of aspect 8, where the location of the at least one tracking device is obtained further based on the sensing information.
Aspect 11 is the method of any of aspects 1 to 10, where the at least one tracking device includes a speaker and a microphone.
Aspect 12 is the method of any of aspects 1 to 11, further including: receiving information associated with one or more locations of one or more walls in at least one environment from the at least one tracking device, where the information is received based on RIRs or AIRs; and modifying at least one parameter associated with performing the set of measurements based on the information associated with the one or more locations of the one or more walls.
Aspect 13 is the method of aspect 12, where the at least one parameter includes at least one of: an acquisition speed for the plurality of AWs, power for receiving or monitoring the plurality of AWs, or an LOS or NLOS configuration for receiving the plurality of AWs.
Aspect 14 is the method of any of aspects 1 to 11, further including: determining at least one object that is not previously presented in an environment enters the environment based on the set of measurements associated with the plurality of AWs from the at least one tracking device; and tracking at least one of a motion or a second location of the at least one object based on the plurality of AWs from the at least one tracking device.
Aspect 15 is the method of any of aspects 1 to 11, further including: determining whether an RF signal is under an LOS or an NLOS condition based on the set of measurements.
Aspect 16 is the method of aspect 15, further including: labeling, de-weighting, or removing the RF signal in response to the RF signal being under the NLOS condition.
Aspect 17 is the method of any of aspects 1 to 16, further including: performing RF communication, tracking, or positioning based on the set of measurements associated with the plurality of AWs.
Aspect 18 is the method of any of aspects 1 to 17, further including: configure or customize the plurality of AWs for the at least one tracking device.
Aspect 19 is the method of any of aspects 1 to 18, where the wireless device is a UE, an AP, or an infrastructure.
Aspect 20 is the method of any of aspects 1 to 19, where the plurality of AWs is associated with a bandwidth between 20 Hz and 23 kHz or a wavelength between 1 meter and 1.5 centimeter.
Aspect 21 is an apparatus for wireless communication at a wireless device, including: a memory; and at least one processor coupled to the memory and, based at least in part on information stored in the memory, the at least one processor is configured to implement any of aspects 1 to 20.
Aspect 22 is the apparatus of aspect 21, further including at least one of a transceiver or an antenna coupled to the at least one processor.
Aspect 23 is the apparatus of aspect 21, further including at least one microphone coupled to the at least one processor.
Aspect 24 is the apparatus of aspect 21, further including at least one speaker coupled to the at least one processor.
Aspect 25 is an apparatus for wireless communication including means for implementing any of aspects 1 to 20.
Aspect 26 is a computer-readable medium (e.g., a non-transitory computer-readable medium) storing computer executable code, where the code when executed by a processor causes the processor to implement any of aspects 1 to 20.

1. An apparatus for communication at a wireless device, comprising:
at least one memory; and
at least one processor coupled to the at least one memory and configured to:
receive an indication of an activation of at least one tracking device, wherein the at least one tracking device is associated with a plurality of acoustic waves (AWs);
perform a set of measurements associated with the plurality of AWs from the at least one tracking device; and
obtain a location of the at least one tracking device based on the set of measurements associated with the plurality of AWs.

2. The apparatus of claim 1, wherein the plurality of AWs is associated with a bandwidth that corresponds to at least one of: an audible acoustic range, an ultrasonic acoustic range, or a subsonic acoustic range.

3. The apparatus of claim 1, wherein the at least one processor is further configured to:
activate the at least one tracking device associated with the plurality of AWs.

4. The apparatus of claim 3, wherein the at least one tracking device is activated based on the indication of the activation.

5. The apparatus of claim 1, wherein the at least one processor is further configured to:
receive the plurality of AWs from the at least one tracking device, wherein the plurality of AWs is received prior to performing the set of measurements.

6. The apparatus of claim 1, wherein the set of measurements includes at least one of:
an angle of arrival (AoA) for the plurality of AWs,
an angle of departure (AoD) for the plurality of AWs,
a time difference of arrival (TDoA) of the plurality of AWs,
a distance range for the plurality of AWs,
a reception time of the plurality of AWs,
a power associated with the plurality of AWs, or
a Doppler associated with the plurality of AWs.

7. The apparatus of claim 1, wherein the at least one processor is further configured to:
transmit a second indication of the location of the at least one tracking device after obtaining the location of the at least one tracking device.

8. The apparatus of claim 1, wherein the at least one processor is further configured to:
receive sensing information associated with at least one environment from the at least one tracking device.

9. The apparatus of claim 8, wherein the sensing information includes at least one of:
material types, absorption coefficients, or reverberation time for one or more objects in the at least one environment,
one or more first locations of one or more walls in the at least one environment, or
one or more second locations of one or more nearby objects to the at least one tracking device.

10-11. (canceled)

12. The apparatus of claim 1, wherein the at least one processor is further configured to:
receive information associated with one or more locations of one or more walls in at least one environment from the at least one tracking device, wherein the information is received based on room impulse responses (RIRs) or acoustic impulse responses (AIRs); and
modify at least one parameter associated with performing the set of measurements based on the information associated with the one or more locations of the one or more walls.

13. The apparatus of claim 12, wherein the at least one parameter includes at least one of:
an acquisition speed for the plurality of AWs,
power for receiving or monitoring the plurality of AWs, or
a line-of-sight (LOS) or non-line-of-sight (NLOS) configuration for receiving the plurality of AWs.

14. The apparatus of claim 1, wherein the at least one processor is further configured to:
determine at least one object that is not previously presented in an environment enters the environment based on the set of measurements associated with the plurality of AWs from the at least one tracking device; and
track at least one of a motion or a second location of the at least one object based on the plurality of AWs from the at least one tracking device.

15. The apparatus of claim 1, wherein the at least one processor is further configured to:
determine whether a radio frequency (RF) signal is under a line-of-sight (LOS) condition or a non-line-of-sight (NLOS) condition based on the set of measurements.

16. The apparatus of claim 15, wherein the at least one processor is further configured to:
label, de-weight, or remove the RF signal in response to the RF signal being under the NLOS condition.

17. The apparatus of claim 1, wherein the at least one processor is further configured to:
perform radio frequency (RF) communication, tracking, or positioning based on the set of measurements associated with the plurality of AWs.

18. The apparatus of claim 1, wherein the at least one processor is further configured to:
configure or customize the plurality of AWs for the at least one tracking device.

19-20. (canceled)

21. A method of communication at a wireless device, comprising:
receiving an indication of an activation of at least one tracking device, wherein the at least one tracking device is associated with a plurality of acoustic waves (AWs);
performing a set of measurements associated with the plurality of AWs from the at least one tracking device; and
obtaining a location of the at least one tracking device based on the set of measurements associated with the plurality of AWs.

22-23. (canceled)

24. The method of claim 23, further comprising:
receiving the plurality of AWs from the at least one tracking device, wherein the plurality of AWs is received prior to performing the set of measurements, and wherein the set of measurements includes at least one of: an angle of arrival (AoA) for the plurality of AWs, an angle of departure (AoD) for the plurality of AWs, a time difference of arrival (TDoA) of the plurality of AWs, a distance range for the plurality of AWs, a reception time of the plurality of AWs, a power associated with the plurality of AWs, or a Doppler associated with the plurality of AWs.

25. The method of claim 21, further comprising:
receiving sensing information associated with at least one environment from the at least one tracking device, wherein the sensing information includes at least one of: material types, absorption coefficients, or reverberation time for one or more objects in the at least one environment, one or more first locations of one or more walls in the at least one environment, or one or more second locations of one or more nearby objects to the at least one tracking device.

26-29.

30. A computer-readable medium storing computer executable code at a wireless device the code when executed by a processor causes the processor to:
receive an indication of an activation of at least one tracking device, wherein the at least one tracking device is associated with a plurality of acoustic waves (AWs);
perform a set of measurements associated with the plurality of AWs from the at least one tracking device; and
obtain a location of the at least one tracking device based on the set of measurements associated with the plurality of AWs.
